(19) United States
(12) Patent Application Publication
(10) Pub. No.: US 2025/0061891 A1
(43) Pub. Date: Feb. 20, 2025

(54) METHOD FOR AUTOMATICALLY CREATING QUESTION-AND-ANSWER COLLECTION, PROGRAM THEREFOR, AND RECORDING MEDIUM

(71) Applicant: INTERACTIVE SOLUTIONS CORP., Tokyo (JP)

(72) Inventor: Kiyoshi SEKINE, Tokyo (JP)

(73) Assignee: INTERACTIVE SOLUTIONS CORP., Tokyo (JP)

(21) Appl. No.: 18/725,817

(22) PCT Filed: Dec. 27, 2022
(86) PCT No.: PCT/JP2022/048434

§ 371 Date: Jul. 1, 2024

(30) Foreign Application Priority Data
Jan. 7, 2022 (JP) 2022-001744
Mar. 17, 2022 (JP) 2022-043206

(51) Int. Cl. G10L 15/08; G10L 15/22

(52) U.S. Cl. CPC G10L 15/08; G10L 15/22; G10L 2015/088

(57) ABSTRACT

[Problem] To provide a method capable of effectively creating and updating a question-and-answer collection by extracting and organizing a question part and an answer part from conversation. [Solution] This method for automatically creating a question-and-answer collection using a computer, causes the computer to execute: a speech analysis step for analyzing speech related to conversation and obtaining phonetic words that are words included in the conversation; a word group analysis step for analyzing which of a plurality of keywords the phonetic words correspond to; a question-and-answer creation step for creating a question and an answer to the question by using the phonetic words; and a question-and-answer acquisition step for obtaining questions and answers related to the keywords recorded in the question-and-answer collection, using the classified questions, the answers to the questions, and the keywords determined to correspond.

### TECHNICAL FIELD

The present invention relates to a method for automatically creating a question-and-answer collection, a program for the method, and a recording medium.

### BACKGROUND ART

JP 6299563 B2 describes a response generating method. This response generating method is basically a method in which a keyword (e.g., “Tonkatsu” (a breaded pork cutlet)) included in a voice (e.g., “Tonkatsu tabeta” (I ate a breaded pork cutlet.)) is replaced with an associative word (e.g., “butaniku” (pork)), and an optional word (e.g., “kaa” (huh), “dane? (didn't you)”) is added to the associative word replaced with (e.g., “butaniku” (pork)), and thus a repetitive response sentence (“Butaniku dane”) is created.

This response generating method is a method of simply making a supportive response to a voice of a user, using various associative words and optional words in various patterns.

### CITATION LIST

### Patent Literature

Patent Literature 1: JP 6299563 B2

### SUMMARY OF INVENTION

### Technical Problem

There is a demand for automatically creating a question-and-answer collection about content of a lecture based on the lecture by a lecturer. There is a demand for creating (updating) a question-and-answer collection based on various previous inquiries, and answers or explanations about some commercial product. An object of the present description is to provide a method for automatically creating a question-and-answer collection that can meet such demands.

### Solution to Problem

The problem described above is based on a finding that a question-and-answer collection can be created effectively by extracting question parts and answer parts to the respective question parts from a conversation and arranging the question parts and the answer parts.

An invention relates to a method for automatically creating a question-and-answer collection using a computer. S denotes a step.

This method includes a voice analyzing step (S101), a word group analyzing step (S102), a question answer creating step (S103), and a question-and-answer set obtaining step (S104).

The voice analyzing step (S101) is a step of analyzing, by the computer, voices about a conversation to obtain voice words, which are words included in the conversation.

The word group analyzing step (S102) is a step of analyzing, by the computer, which of a plurality of keywords matches a voice word.

The question answer creating step (S103) is a step of creating, by the computer, a question and an answer to the question, using the voice words.

The question-and-answer set obtaining step (S104) is a step of obtaining, by the computer, using a classified question and an answer to the question, and a keyword that is determined to be matching in the foregoing step, a question and an answer about the keyword (the keyword determined to be matching in the foregoing step) that are to be recorded in the question-and-answer collection.

It is preferable that the above method further include a category analyzing step (S201). The category analyzing step is a step of analyzing, by the computer, a category of a question and an answer. The question and the answer are about some keyword. Thus, for example, the computer can analyze a category of the question and the answer by referring to a dictionary in which the keyword is categorized. In this case, in this method, the question-and-answer collection stores the question and the answer that are to be recorded in the question-and-answer collection in a category analyzed in the category analyzing step.

It is preferable that the above method further include a content related word reading step (S301), a content related word determining step (S302), and a content storing step (S303).

The content related word reading step (S301) is a step of reading, by the computer, a content related word that is related to content included in a presentation material about a conversation.

The content related word determining step (S302) is a step of determining, by the computer, whether a keyword is a content related word.

The content storing step (S303) is a step of storing, by the computer, when a keyword is a content related word, content in the question-and-answer collection, in association with a question and an answer that are to be recorded in the question-and-answer collection. In this case, the question-and-answer collection may store the content in association with a page of a presentation material related to the content.

The present description also discloses a program for implementing the above-described method in a computer and discloses a non-transitory computer readable information recording medium that stores the program.

### Advantageous Effects of Invention

According to the present invention, it is possible to effectively create and update a question-and-answer collection by extracting question parts and answer parts to the respective question parts from a conversation and arranging the question parts and the answer parts.

### BRIEF DESCRIPTION OF DRAWINGS

FIG. 1 is a conceptual diagram of a question-and-answer collection automatically creating device.

FIG. 2 is a flowchart for describing a method for automatically creating a question-and-answer collection.

### DESCRIPTION OF EMBODIMENTS

An embodiment for practicing the present invention will be described below with reference to the drawings. The present invention is not limited to the embodiment described below but also includes modifications that are made by those skilled in the art as appropriate within a scope obvious to those skilled in the art from the following embodiment.

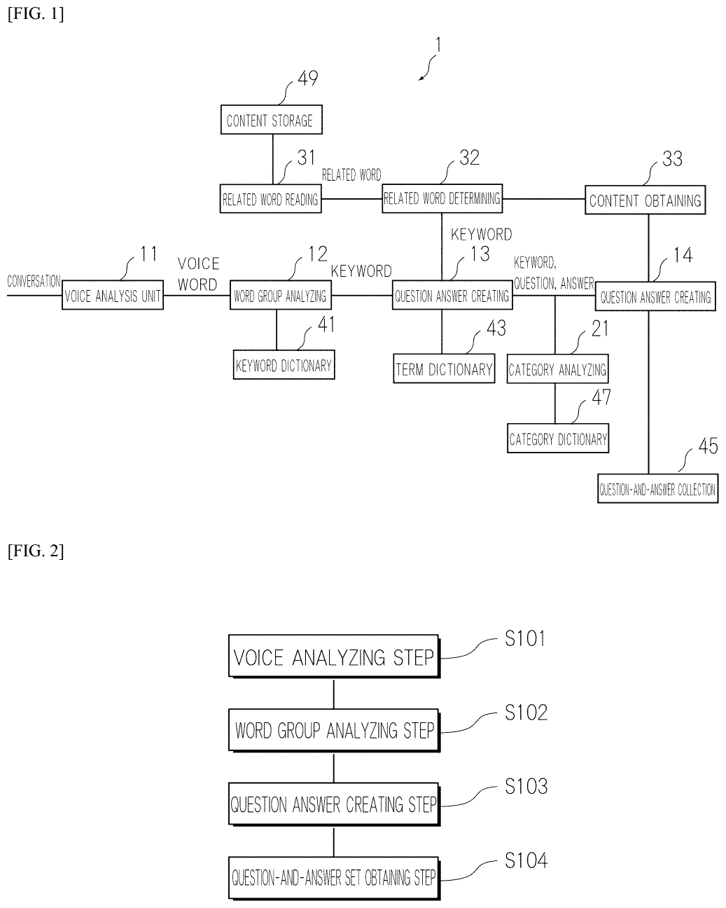

FIG. 1 is a conceptual diagram of a question-and-answer collection automatically creating device. As illustrated in FIG. 1, this device 1 includes a voice analysis unit 11, a word group analysis unit 12, a question answer creation unit 13, and a question-and-answer set obtaining unit 14. This device 1 may further include any one of elements including a category analysis unit 21, a content related word reading unit 31, a content related word determination unit 32, and a content obtaining unit 33. This system is a device implemented by a computer or a processor.

The computer includes an input unit, an output unit, a control unit, a computation unit, and a storage unit, and the elements are connected together with a bus or the like so as to exchange information with one another. For example, the storage unit may store a control program and may store various types of information. When receiving predetermined information from the input unit, the control unit reads the control program stored in the storage unit. The control unit then reads information stored in the storage unit and transfers the information to the computation unit as appropriate. The control unit also transfers received information to the computation unit as appropriate. The computation unit performs computational processing using received various types of information and stores a computation result in the storage unit. The control unit reads the computation result stored in the storage unit and outputs the computation result through the output unit. Various types of processing and steps are executed in this manner. The various types of processing are executed by the units and means. The computer may be a computer including a processor that implements various functions and various steps.

### Question-And-Answer Collection Automatically Creating Device

A question-and-answer collection automatically creating device 1 is a device for automatically creating a question-and-answer collection, such as a question-and-answer set, a role play, or a question bank, by automatically extracting questions and answers from a conversation based on the computer, and classifying and arranging the questions and the answers.

The voice analysis unit 11 is an element for analyzing voices about a conversation to obtain voice words, which are words included in the conversation. The word group analysis unit 12 is an element for analyzing which of a plurality of keywords matches a voice word. The question answer creation unit 13 is an element for creating a question and an answer to the question, using the voice words. The question-and-answer set obtaining unit 14 is an element for obtaining, using a classified question and an answer to the question, and a keyword that is determined to be matching, a question and an answer about the keyword (the keyword determined to be matching) that are to be recorded in the question-and-answer collection.

The category analysis unit 21 is an element for analyzing a category of a question and an answer.

The content related word reading unit 31 is an element for reading a content related word that is related to content included in a presentation material about a conversation. The content related word determination unit 32 is an element for determining whether a keyword is a content related word. The content obtaining unit 33 is an element for storing, when a keyword is a content related word, content in the question-and-answer collection in association with a question and an answer that are to be recorded in the question-and-answer collection.

FIG. 2 is a flowchart for describing a method for automatically creating a question-and-answer collection.

This method includes a voice analyzing step (S101), a word group analyzing step (S102), a question answer creating step (S103), and a question-and-answer set obtaining step (S104).

### Voice Analyzing Step (S101)

The voice analyzing step (S101) is a step of analyzing, by the computer (the voice analysis device 11), voices about a conversation to obtain voice words, which are words included in the conversation. From an input unit such as a microphone, the conversation is input into the question-and-answer collection automatically creating device 1. The conversation may be a speech, a conversation between an MR and a doctor, or a lecture as long as the conversation is recorded in a form of human voices. Although the conversation may be a talking to oneself, the conversation is preferably an exchange of words between two persons or among more than two persons. The conversation input into the automatically creating device 1 is converted into a digital signal and stored in a storage unit as appropriate.

An example of the conversation is as follows.
Doctor: Recently, I have often prescribed PUCHIN, I think. Because PUCHIN produces a strong effect with one dose.
   MR: I see. Our AIPURO tablets have an extremely high selectivity for DPP4, 80 times the selectivity of PUCHIN tablets for DPP4. This is why AIPURO tablets tend to produce a stronger hypotensive action than PUCHIN tablets in their effectiveness.

Known voice analysis software is used. A known program refers to words stored in the storage unit in a form of, for example, a term dictionary to perform voice analysis on the conversation stored in the storage unit. Voice words obtained from the voice analysis are stored in the storage unit as appropriate.

An example of the voice words is as follows.
Doctor: Recently, I have often prescribed PUCHIN, I think. Because PUCHIN produces a strong effect with one dose.
   MR: I see. Our AIPURO tablets have an extremely high selectivity for DPP4, 80 times the selectivity of PUCHIN tablets for DPP4. This is why AIPURO tablets tend to produce a stronger hypotensive action than PUCHIN tablets in their effectiveness.

### Word Group Analyzing Step (S102)

The word group analyzing step (S102) is a step of analyzing, by the computer, which of a plurality of keywords matches a voice word. The plurality of keywords may be keywords that are registered in the computer beforehand. The plurality of keywords may be keywords that are stored in the storage unit when the word group analyzing step (S102) is performed. The computer may include a keyword dictionary 41 in which the plurality of keywords are recorded. The plurality of keywords may further includes a keyword candidate extracting step of obtaining a candidate for a keyword from the voice words and a keyword updating step of updating, using the candidate for the keyword extracted in the keyword extracting step, a keyword registered in the keyword dictionary, to update the plurality of registered keywords. When no keywords are registered in the keyword dictionary 41 beforehand, a plurality of keywords will be registered (a state where the keyword dictionary 41 includes no keywords will be updated to a state where the keyword dictionary 41 newly includes a plurality of new keywords) by this keyword updating step. In this manner, when a new keyword that is not registered in the keyword dictionary is included in the voice words, a plurality of keywords included in the keyword dictionary will be updated. The plurality of keywords in the word group analyzing step may be the plurality of registered keywords that are obtained by the keyword updating step. For example, the computer analyzes parts of speech of words included in the voice words and extracts a noun. The computer then searches the Internet with the extracted noun. At this time, the computer may search the Internet with the extracted noun together with a keyword that is stored in the storage unit in relation to a presentation material or a keyword that is stored in the storage unit in relation to some page of a presentation material. As a result, when the number of hits of the noun is not less than a certain number or when the noun and the keyword are used in the same search site at least to a certain degree (or when the noun and the keyword are used as tags of the same article at least to a certain degree), the noun may be adopted as a new keyword. In this manner, a term included in the voice words may be registered as a new keyword in the keyword dictionary, and thus the plurality of keywords may be updated. The question-and-answer collection automatically creating device 1 includes, for example, the keyword dictionary 41 that stores a plurality of keywords about content of a conversation. The computer reads keywords from the keyword dictionary and compares the keywords against the voice terms stored in the storage unit under an instruction from the program. In this manner, the computer (the word group analysis device 12) can analyze which of the plurality of keywords registered beforehand matches a voice word. In the keyword dictionary, each of the keywords may be stored being assigned its category classification, as will be described later.

For example, in a case where the conversation is about an imaginary hypotensive agent named AIPURO tablet, a keyword dictionary about the conversation stores keywords including PUCHIN, PUCHIN tablet, AIPURO, AIPURO tablet, effect, effectiveness, hypotensive action, and selectivity. These keywords are preferably stored with category classifications. The keyword dictionary may store related words in relation to the keywords.

An example of the voice words after the word group analysis is as follows. Underlined words are keywords.
Doctor: Recently, I have often prescribed PUCHIN, I think. Because PUCHIN produces a strong effect with one dose.
   MR: I see. Our AIPURO tablets have an extremely high selectivity for DPP4, 80 times the selectivity of PUCHIN tablets for DPP4. This is why AIPURO tablets tend to produce a stronger hypotensive action than PUCHIN tablets in their effectiveness.

### Question Answer Creating Step (S103)

The question answer creating step (S103) is a step of creating, by the computer, a question and an answer to the question, using the voice words. A program that analyzes the voice words for a sentence structure and a context is known. For example, a term dictionary 43 for analyzing each word is present, and a relationship among a noun, a verb, and the like is analyzed by referring to the term dictionary. In such a manner, a relationship among voice words in a conversation can be analyzed. Therefore, the question answer creation device 13 can create one or more questions and one or more answers to the one or more questions, using a word included in the voice words. In this case, the one or more questions preferably include the keyword (or a related word of the keyword). The computer reads the voice words from the storage unit, and, receiving an instruction from the program, creates a question including a keyword included in the voice words or including a related word of the keyword and creates an answer to the question. The question and the answer are based on the voice words. The created question and the created answer to the question are stored in the storage unit as appropriate.

Examples of the question and the answer are as follows.
Question 1: What effect of AIPURO tablets is stronger than that of PUCHIN tablets?
Answer 1: AIPURO tablets have a strong hypotensive action.
Question 2: What makes AIPURO tablets stronger in hypotensive action than PUCHIN tablets?
Answer 2: AIPURO tablets have a strong hypotensive action because their selectivity for DPP4 is 80 times that of PUCHIN tablets.
Question 3: How many doses of PUCHIN tablet are required to produce its effect?
Answer 3: One dose of PUCHIN tablet can produce the effect.

### Question-And-Answer Set Obtaining Step (S104)

The question-and-answer set obtaining step (S104) is a step of obtaining, by the computer, using a created question and a created answer to the question, and a keyword that is determined to be matching in the foregoing step, a question and an answer about the keyword (the keyword determined to be matching in the foregoing step) that are to be recorded in the question-and-answer collection 45.

For example, in relation to the keyword “AIPURO tablet,” Question 1 and Answer 1, and Question 2 and Answer 2 are stored in the storage unit. In relation to the keyword “PUCHIN tablet,” Question 1 and Answer 1, Question 2 and Answer 2, and Question 3 and Answer 3 are stored in the storage unit.

By the above steps, for example, it is possible to automatically create a question-and-answer collection about content of a lecture based on the lecture by a lecturer. Thus, it is possible for a student or a listener to easily perform a task of checking an outcome of the lecture. It will be also possible to automatically create a test for checking an outcome after the lecture.

In addition, by the above steps, a question-and-answer collection can be created (updated) based on various previous inquiries, and answers or explanations about some commercial product.

### Category Analyzing Step (S201)

It is preferable that the above method further include a category analyzing step (S201).

The category analyzing step is a step of analyzing, by the computer, a category of a question and an answer. Concept of categories can be freely created by a user's setting. For example, in a case where a target conversation is about a medicine, examples of the categories include medicine name, target disease, effect, side effect, presence or absence of generic drug, active ingredient, contraindication and drug manufacturer name. For example, in a case where the conversation is of a lecture on the history of the Edo period (a period in the history of Japan), examples of the categories include date in history, battle, region, name of daimyo (Japanese feudal lord), and culture. A category dictionary is only required to store a plurality of words in relation to these category names. Then, the category analysis unit 21 can analyze a word included in the voice words to determine to which category the word belongs. The question and the answer are about some keyword. Thus, for example, the computer can analyze a category of the question and the answer by referring to a category dictionary 47 in which the keyword is categorized. In addition, for example, in the question answer creating step (S103), a word that is included in the voice words and other than the keyword is also analyzed. Based on this word, the category of the question and the answer is to be analyzed. The word used in this analysis may be a keyword or may be a word other than a keyword. In any case, by referring to the category dictionary, it is possible to categorize a conversational text, or a created question and answer.

The question-and-answer collection automatically creating device 1 may further include a topic word storage unit (a topic word dictionary) that stores a topic word related to a voice word (a term in a conversation) or a keyword. Then, using this topic word, a question and an answer may be classified to be related to the topic word, and stored in the question-and-answer collection. For example, the topic word storage unit is only required to store the topic word of obesity in relation to a keyword that is assumed to be used in a conversation about an obese gene, obesity, and an obesity experimental animal. The topic word may be a unified term or a superordinate concept term of a plurality of keywords. By using the topic word, it will be possible to perform a search more quickly. An example of the topic word includes disease name, drug name, active ingredient name, and drug manufacturer name. That is, the topic word can be considered to be a secondary converted word about a voice word (a term in a conversation). The topic word may be a term that is assigned as being a suitable term to be used for searching for a plurality of types of keywords. Alternatively, the topic word may be about a message.

In the following sentences, underlined words are words used in the categorization in the analysis in the question answer creating step (S103).
Doctor: Recently, I have often prescribed PUCHIN, I think. Because PUCHIN produces a strong effect with one dose.
   MR: I see. Our AIPURO tablets have an extremely high selectivity for DPP4, 80 times the selectivity of PUCHIN tablets for DPP4. This is why AIPURO tablets tend to produce a stronger hypotensive action than PUCHIN tablets in their effectiveness.

In this example, there are words related to “effect” included in the category dictionary: “effect,” “selectivity,” and “hypotensive action,” and thus a question and an answer including a term related to these words are categorized into “effect” and stored in the storage unit. In this manner, a question and an answer that are to be recorded in the question-and-answer collection are stored in a category analyzed in the category analyzing step.

This system can create a question-and-answer collection effectively in accordance with categorized categories.

For example, it is assumed that there are Question 11 and Answer 11, Question 12 and Answer 12, Question 13 and Answer 13, Question 14 and Answer 14, . . . in relation to “effect” that is a first category, and there are Question 21 and Answer 21, Question 22 and Answer 22, Question 23 and Answer 23, Question 24 and Answer 24, . . . in relation to “side effect” that is a second category.

A question-and-answer set creation unit (a role play creation unit) reads a predetermined number of questions from each of the categories and creates a collection of the questions and answers to the questions. A created question-and-answer set or role play is stored in the storage unit as appropriate. In this manner, it is possible to easily create a question-and-answer collection based on a conversation. It is also possible to easily create a comprehension test (and answers) about a lecture.

For example, as a comprehension test about the foregoing AIPURO tablet, the system selects Question 12 and Answer 12, and Question 13 and Answer 13 in relation to “effect” and selects Question 21 and Answer 21, Question 22 and Answer 22, and Question 24 and Answer 24 in relation to “side effect,” thus automatically creating a comprehension test for some MR.

It is preferable that the above method further include a content related word reading step (S301), a content related word determining step (S302), and a content storing step (S303).

The method need not include these steps as long as a presentation material related to a keyword included in a question-and-answer set, a page of the presentation material or a material is stored, and the related material being stored can be read in relation to a keyword included in some question and answer. Thus, when a user refers to an answer to a question, it will be possible for the user to, for example, browse a related material related to the answer. In the following example, a presentation material or information on a part of the presentation material is obtained as related information on some question and answer, and the presentation material or the part can be read in relation to the question and the answer. Note that what is stored as the information related to some question and answer is not limited to the presentation material or the part and may be a material, a page or a part of the material.

### Content Related Word Reading Step (S301)

The content related word reading step (S301) is a step of reading, by the computer (the content related word reading unit 31), a content related word that is related to content included in a presentation material about a conversation. For example, it is assumed that the conversation is about AIPURO tablets. Thus, the device 1 analyzes a topic of the conversation based on voice words. The device 1 may read a keyword or a topic word, compare the keyword or the topic word with the voice words, and analyze the topic of the conversation. As a result, for example, the device 1 understands that the conversation is about AIPURO tablets. The storage unit of the device 1 stores various presentation materials in relation to various topics. In addition, the presentation materials each store a plurality of pages or pieces of content. To make these pieces of content easy to search for, the storage unit stores a content related word in relation to content. The device 1 reads this content related word from the storage unit. The pieces of content may be pages of a presentation material, may be the entire presentation material, may be the entire text, or may be a part of a text about a content related word. It is assumed that a conversation (including an explanation or a lecture) is made with the computer opening some presentation material. The device 1 may receive information about the presentation material. The device 1 then reads information about the presentation material about the conversation from the presentation storage unit (content storage unit) 49. The content storage unit 49 stores the entire presentation material and a content related word that is related to content included in each page or each part of a presentation. The content storage unit 49 is configured such that the entire corresponding presentation material and content included in each page or each part of the presentation can be read using these content related words.

### Content Related Word Determining Step (S302)

The content related word determining step (S302) is a step of determining, by the computer (the content related word determination unit 32), whether a keyword is a content related word. This keyword is a keyword about a voice word that is analyzed by the word group analysis unit 12. For example, each question and answer is stored in relation to a keyword in the storage unit (the question-and-answer collection 45). The device 1 reads the keyword and compares the read keyword with content related words. As a result, when the keyword is any one of the content related words, the keyword is to be stored in the storage unit in such a manner that content related to the content related word can be read. For example, information for reading this content is stored in association with some question and answer. In this manner, related content will be associated with a question and an answer to the question.

### Content Obtaining Step (S303)

The content obtaining step (S303) is a step of storing, by the computer, when a keyword is a content related word, (information for reading) content in the question-and-answer collection in association with a question and an answer that are to be recorded in the question-and-answer collection. In this case, the question-and-answer collection may store content in association with (information for reading) a page of a presentation material related to the content. Thus, when a user performs a question-and-answer session or a role playing session and refers to an answer, it will be possible to read the content and the page of the presentation material and allow the user to browse the content and the page.

The present description also discloses a program for implementing the above-described method in a computer and discloses a non-transitory computer readable information recording medium that stores the program. An example of the information recording medium is a CD, a CD-ROM, a DVD, a USB memory, a hard disk, and a disk in a server.

### INDUSTRIAL APPLICABILITY

The present invention may be used in information-related industries.

### REFERENCE SIGNS LIST

1 question-and-answer collection automatically creating device
11 voice analysis unit
12 word group analysis unit
13 question answer creation unit
14 question-and-answer set obtaining unit
21 category analysis unit
31 content related word reading unit
32 content related word determination unit
33 content obtaining unit

1. A method for automatically creating a question-and-answer collection using a computer, the method comprising,
by the computer:
a voice analyzing step of analyzing a voice about a conversation to obtain a voice word, the voice word being a word included in the conversation;
a word group analyzing step of analyzing which of a plurality of keywords matches the voice word;
a question answer creating step of creating a question and an answer to the question, using the voice word; and
a question-and-answer set obtaining step of obtaining, using a keyword that is determined to match the question being classified and an answer to the question, a question and an answer about the keyword, the question and the answer being to be recorded in a question-and-answer collection.

2. The method according to claim 1, further comprising:
a keyword candidate extracting step of obtaining a candidate for a keyword from the voice word; and
a keyword updating step of updating, using the candidate for the keyword extracted in the keyword candidate extracting step, a keyword registered in a keyword dictionary, to update a plurality of registered keywords, wherein
the plurality of keywords in the word group analyzing step are the plurality of registered keywords that are obtained by the keyword updating step.

3. The method according to claim 1, further comprising
a category analyzing step of analyzing a category of the question and the answer, wherein
the question-and-answer collection stores the question and the answer in the category analyzed in the category analyzing step, the question and the answer being to be recorded in the question-and-answer collection.

4. The method according to claim 1, further comprising:
a content related word reading step of reading, by the computer, a content related word that is related to content included in a presentation material about the conversation;
a content related word determining step of determining whether the keyword is the content related word; and
a content obtaining step of, when the keyword is the content related word, storing the content in the question-and-answer collection in association with the question and the answer to be recorded in the question-and-answer collection.

5. The method according to claim 4, wherein the question-and-answer collection stores a page of a presentation material related to the content in association with the content.

6. A program for implementing, in a computer, a method for automatically creating a question-and-answer collection, the method comprising:
a voice analyzing step of analyzing a voice about a conversation to obtain a voice word, the voice word being a word included in the conversation;
a keyword extracting step of obtaining a keyword from the voice word;
a keyword updating step of updating, using the keyword extracted in the keyword extracting step, a keyword registered in a keyword dictionary, to obtain a plurality of registered keywords;
a word group analyzing step of analyzing which of the plurality of registered keywords matches the voice word; and
a question-and-answer set obtaining step of classifying the voice word into a question and an answer to the question based on the keyword analyzed in the word group analyzing step, to obtain a question and an answer to be recorded in the question-and-answer collection.

7. A non-transitory computer readable information recording medium storing the program according to claim 6.
